(19) United States
(12) Patent Application Publication
(10) Pub. No.: US 2007/0289760 A1
(43) Pub. Date: Dec. 20, 2007

(54) Shock attenuating coupling device and rotary impact tool

(75) Inventors: Robert E. Sterling, Spokane, WA (US); Matthew R. Sterling, Spokane, WA (US)

Correspondence Address: WELLS ST. JOHN P.S., 601 W. FIRST AVENUE, SUITE 1300, SPOKANE, WA, 99201, US

(73) Assignee: Exhaust Technologies, Inc.

(21) Appl. No.: 11/454,240

(22) Filed: Jun. 16, 2006

(51) Int. Cl. B25D 11/00

(52) U.S. Cl. 173/104

(57) ABSTRACT

A shock attenuating coupling device is provided for a rotary impact tool for drivingly connecting a hammer mechanism to a drive anvil. The shock attenuating coupling device includes a first coupling member, a second coupling member, a rolling member and a spring. The first coupling member has a longitudinal drive portion with an input end configured to couple for rotation with a hammer mechanism. The first coupling member also has an output end with a first engagement portion having a first ramped groove. The second coupling member is coaxial with the first coupling member and has an output end configured to couple for rotation with a drive anvil. The second coupling member also has an input end with a second engagement portion having a second ramped groove extending in a direction opposite a direction of the ramped groove. The second engagement portion is configured to cooperate with the first engagement portion. The rolling member is provided between the first ramped groove and the second ramped groove. The spring is configured to engage the first engagement portion and the second engagement portion to drive the rolling member to a resting lower-most position within each of the first ramped groove and the second ramped groove.

### TECHNICAL FIELD

This invention pertains to rotary impact tools. More particularly, the present invention relates to rotary impact tools having a transient torque absorbing drive coupling provided intermediate a hammer mechanism and a drive anvil.

### BACKGROUND OF THE INVENTION

Numerous designs are known for making rotary impact tools. U.S. Pat. Nos. 2,285,638; 3,661,217; and 6,491,111 disclose several variations of rotary impact tools having conventional rotary impact mechanisms. Such mechanisms are configured to deliver rotary forces via a series of transient impact blows which enables a human operator to handle the impact wrench while delivering relatively high torque forces in short duration impact blows. By applying relatively short duration high torque impact blows, a normal human being is rendered with the ability to physically hold onto the impact wrench while rendering the relatively high torque forces. If these forces were delivered in a continuous manner, a human operator would be required to impart an opposite continuous reaction force on the impact wrench which would prove to be too great for the operator.

One problem with the rotary impact tools mentioned above is the inability to deliver relatively high torque forces in short duration impact blows while reducing the peak transient forces generated at the instance of impact within the rotary impact mechanism.

Accordingly, it would be advantageous to control, or limit transmission of peak transient forces that are generated via a rotary impact mechanism of a rotary impact tool to an anvil.

### SUMMARY OF THE INVENTION

A shock attenuating coupling device is provided for use on a rotary impact tool between an impact mechanism and an anvil. One or more resilient members are configured to interact between a drive shaft and a driven shaft in order to provide a resilient rotary coupling device interposed between a hammer mechanism and a drive anvil. In one case, a pair of interacting coaxial members are supported for rotation against a rolling member interposed between the members, each member having a sloped circumferential surface for interacting with the rolling member. A spring is provided to engage together the members. When torque between the members exceed the spring force, the rolling member rides up each sloped circumferential surface to axially drive apart the members, thereby imparting torsional displacement and shock attenuation between the members.

According to one aspect, a shock attenuating coupling device is provided for a rotary impact tool for drivingly connecting a hammer mechanism to a drive anvil. The shock attenuating coupling device includes a first coupling member, a second coupling member, a rolling member and a spring. The first coupling member has a longitudinal drive portion with an input end configured to couple for rotation with a hammer mechanism. The first coupling member also has an output end with a first engagement portion having a first ramped groove. The second coupling member is coaxial with the first coupling member and has an output end configured to couple for rotation with a drive anvil. The second coupling member also has an input end with a second engagement portion having a second ramped groove extending in a direction opposite a direction of the ramped groove. The second engagement portion is configured to cooperate with the first engagement portion. The rolling member is provided between the first ramped groove and the second ramped groove. The spring is configured to engage the first engagement portion and the second engagement portion to drive the rolling member to a resting lower-most position within each of the first ramped groove and the second ramped groove.

According to another aspect, a rotary impact tool is provided having a housing, a hammer mechanism, a drive anvil and a resilient rotary coupling device. The resilient rotary coupling device has a pair of engagement plates provided in coaxial relation. Each plate has a sloped circumferential engagement surface. A rolling element is interposed between the engagement surfaces. A compression spring is configured to drive together the pair of engagement plates. Relative rotational displacement between the hammer mechanism and the drive anvil causes the rolling element to translate up each sloped circumferential engagement surface, thereby acting to compress the spring so as to attenuate impact forces from the hammer mechanism to the drive anvil.

According to yet another aspect, a rotary impact attenuating device is provided for an impact tool having a first coupling member, a second coupling member, a rolling element and a spring. The first coupling member has a drive shaft and a drive plate with a sloped raceway. The second coupling member is coaxial with the first coupling member and has a drive shaft and a driven plate with a sloped raceway. The rolling element is engaged between the rolling raceways. The spring is compressively engaged against one of the first coupling member and the second coupling member to drive the rolling element to a lower-most position in each of the rolling raceways when below a threshold torque limit.

### BRIEF DESCRIPTION OF THE DRAWINGS

Preferred embodiments of the invention are described below with reference to the following accompanying drawings.

FIG. 1 is a side elevational view of a rotary impact tool having a shock attenuating coupling device interposed between a rotary impact mechanism and an anvil in accordance with one embodiment of the present invention.

FIG. 2 is an enlarged partial view, shown in vertical centerline cross-section, of an air supply, trigger mechanism, and muffler provided in a handle of the rotary impact tool of FIG. 1.

FIGS. 3A-C, assembled together according to the arrangement depicted in FIG. 3, provide a simplified, exploded perspective view of the rotary impact tool of FIGS. 1-2.

FIGS. 4A and 4B together provide an enlarged partial view, shown in partial vertical centerline cross-section, of a pneumatic valve, pneumatic motor, rotary impact mechanism, shock attenuating coupling device, and anvil for the rotary impact tool of FIGS. 1-3.

FIG. 5 is a plan view of a selected sub-assembly of the hammer mechanism used in the rotary impact tool of FIGS. 1-3.

FIG. 6 is a vertical sectional view taken along line 6-6 of FIG. 5.

FIG. 7 a vertical sectional view taken along line 7-7 of FIG. 5.

FIG. 8 a perspective view of a selected sub-assembly of the hammer mechanism of FIGS. 1-3.

FIG. 9 is a vertical sectional view corresponding with that taken in FIG. 6 and further showing the ball.

FIG. 10 a vertical sectional view taken later in time than that depicted in FIG. 9 and showing the pins just prior to being driven toward the anvil (not shown).

FIG. 11 a vertical sectional view taken later in time than that depicted in FIG. 10 and showing the pins being driven toward the anvil (not shown).

FIG. 12 is an enlarged, exploded and perspective view of the shock attenuating coupling device of FIG. 4 and the hammer mechanism.

FIG. 13 is a partial sectional view of the shock attenuating coupling device of FIG. 12 prior to realizing a shock overload.

FIG. 14 is a partial sectional view taken later in time than FIG. 13 during a relative torsional displacement between the first coupling member and the second coupling member resulting from a shock overload.

FIG. 15 is a face view of an engagement portion for the first coupling member.

FIG. 16 is a face view of an engagement portion for the second coupling member.

FIG. 17 is an enlarged partial and sectional view of a cylindrical head milling bit used during formation of each sloped groove, or ball bearing raceway in the first and second coupling members.

FIG. 18 is a partial sectional view of the shock attenuating coupling device of FIGS. 12-14 prior to realizing a shock overload and depicting a ball oriented within respective bottom-most portions of each cooperating ramped, circumferential groove.

FIG. 19 is an enlarged sectional view taken from the encircled region 19 of FIG. 18 during torsional loading, but prior to torsional damping.

FIG. 20 is an enlarged sectional view taken from the encircled region 20 during torsional damping.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Reference will now be made to a preferred embodiment of Applicant's invention for a rotary impact tool having a shock attenuating coupling device between an impact mechanism and an anvil. While the invention is described by way of a preferred embodiment, it is understood that the description is not intended to limit the invention to such embodiment, but is intended to cover alternatives, equivalents, and modifications which may be broader than the embodiment, but which are included within the scope of the appended claims.

In an effort to prevent obscuring the invention at hand, only details germane to implementing the invention will be described in great detail, with presently understood peripheral details being incorporated by reference, as needed, as being presently understood in the art.

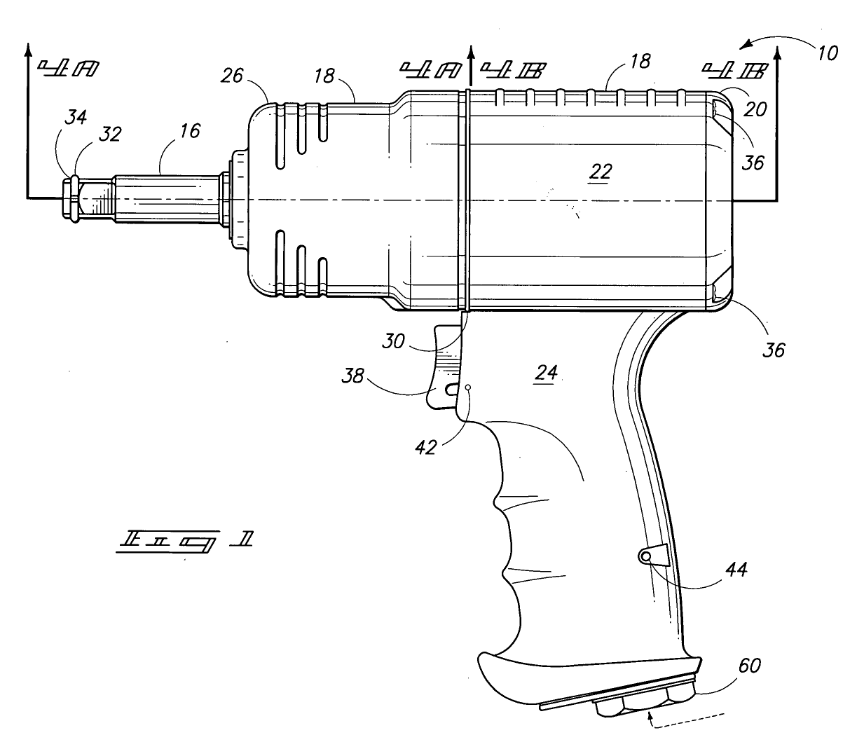

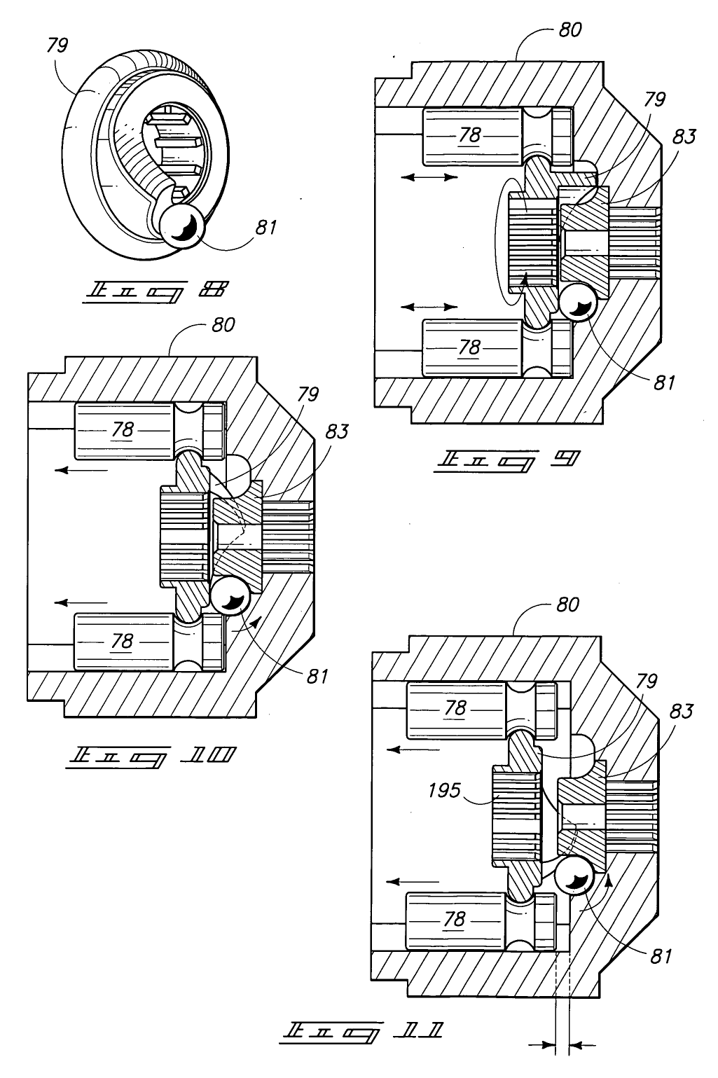

FIGS. 1-20 illustrate a rotary impact tool in the form of a pneumatic impact wrench 10 according to one aspect of the present invention. More particularly, impact wrench 10 is provided with a resilient rotary coupling device 12 (see FIGS. 34 and 12-20) that is provided between an impact mechanism, or hammer 14, and an anvil 16. According to one construction, the resilient coupling device provides resilient, or shock-attenuating rotational coupling in a forward direction, but provides no resilience in an opposite, reverse direction. Hence, when used in a torque wrench, the resilient coupling device limits peak transient impact loads being generated from the wrench and transferred to the anvil when tightening a fastener with a drive socket (not shown) that is provided on the anvil. However, the torque wrench generates greater peak transient impact loads when operated in a reverse, or loosening direction, which ensures that greater forces are generated for loosening a secured fastener. However, an optional configuration provides a resilient coupling device that acts in both forward and reverse directions to provide resilient torsional shock attenuation in both forward and reverse directions. Further optional, shock attenuation can be provided only in a reverse direction.

As shown in FIG. 1, wrench 10 has a tool housing 18 comprising a motor housing member 20 and a hammer housing member, or nose piece, 26. Motor housing member 20 includes a hollow motor casing 22 and an integrally formed handle 24. Optionally, handle 24 can be formed from a separate piece that is fastened onto casing 22. A resilient front gasket 30 is provided between members 20 and 26 via four screws 36. Anvil 16 terminates at a distal end with an anvil collar 32 provided about a resilient o-ring 34 within a recess about anvil 16. Anvil collar 32 is urged in compression in a radially-inward direction when retaining and releasing an impact socket, or tool from anvil 16.

Handle 24 of impact wrench 10 includes a trigger 38 that is guided for compression and release via a force-fit spring pin 42, as shown in FIG. 1. Another spring pin 44 is provided in handle 24 to anchor an air inlet fitting, or member, 60.

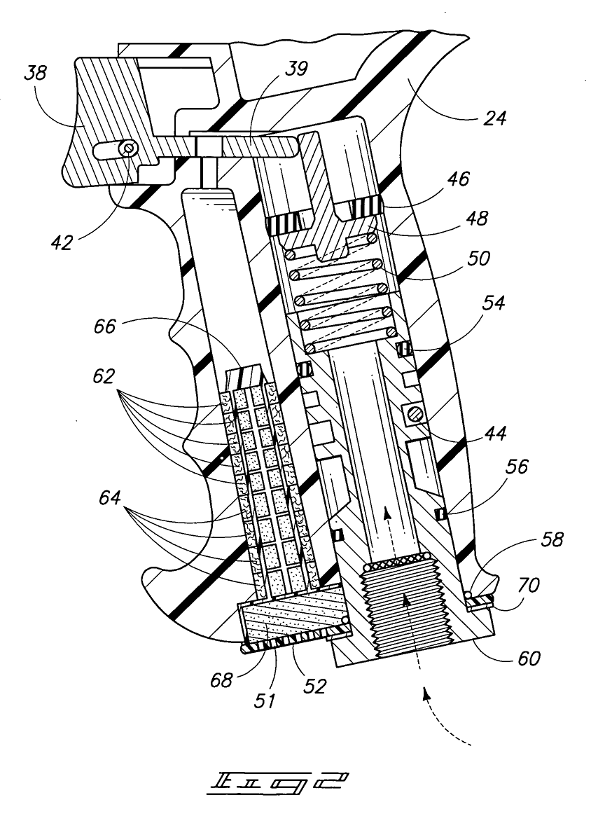

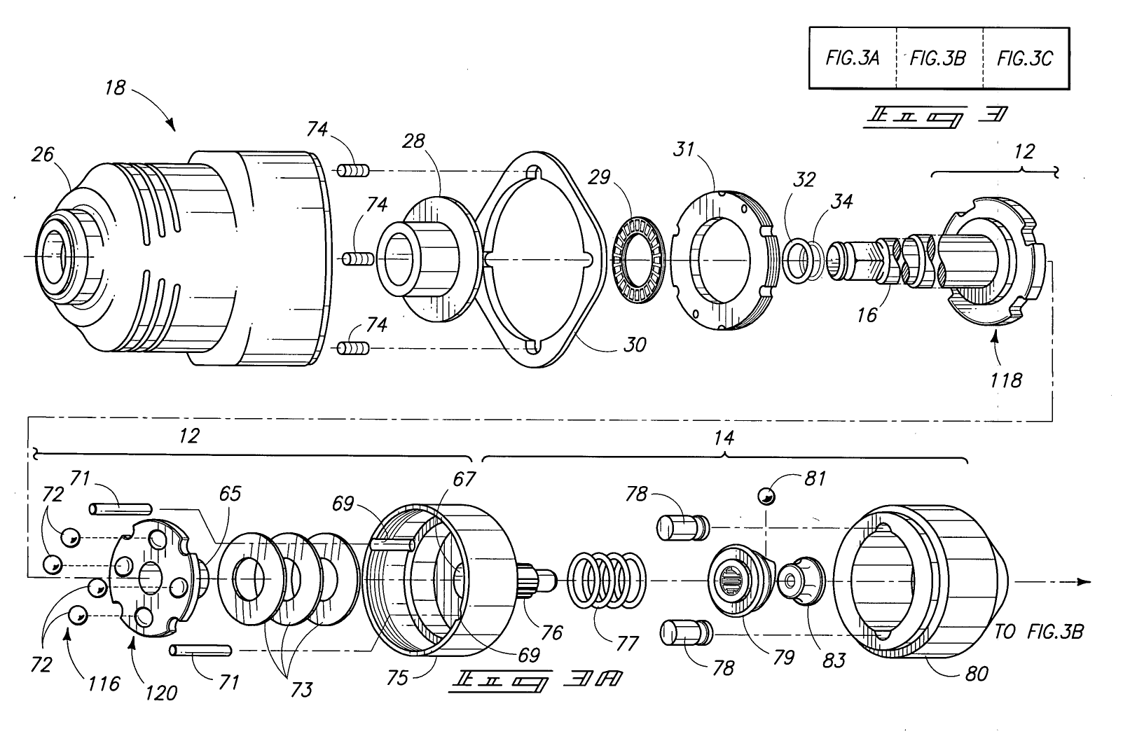

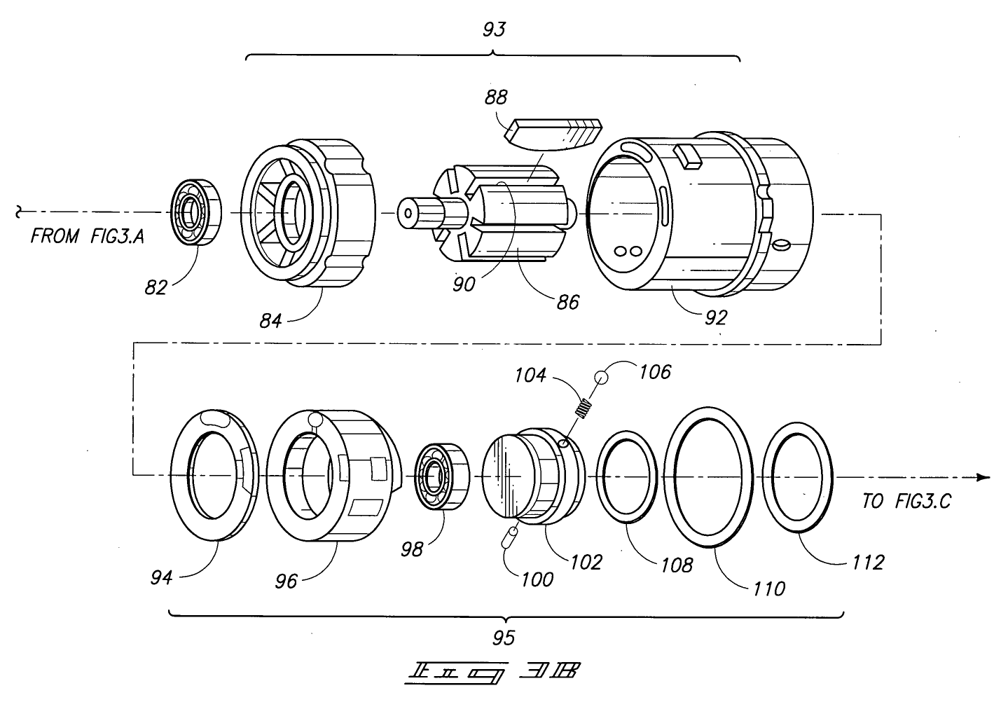

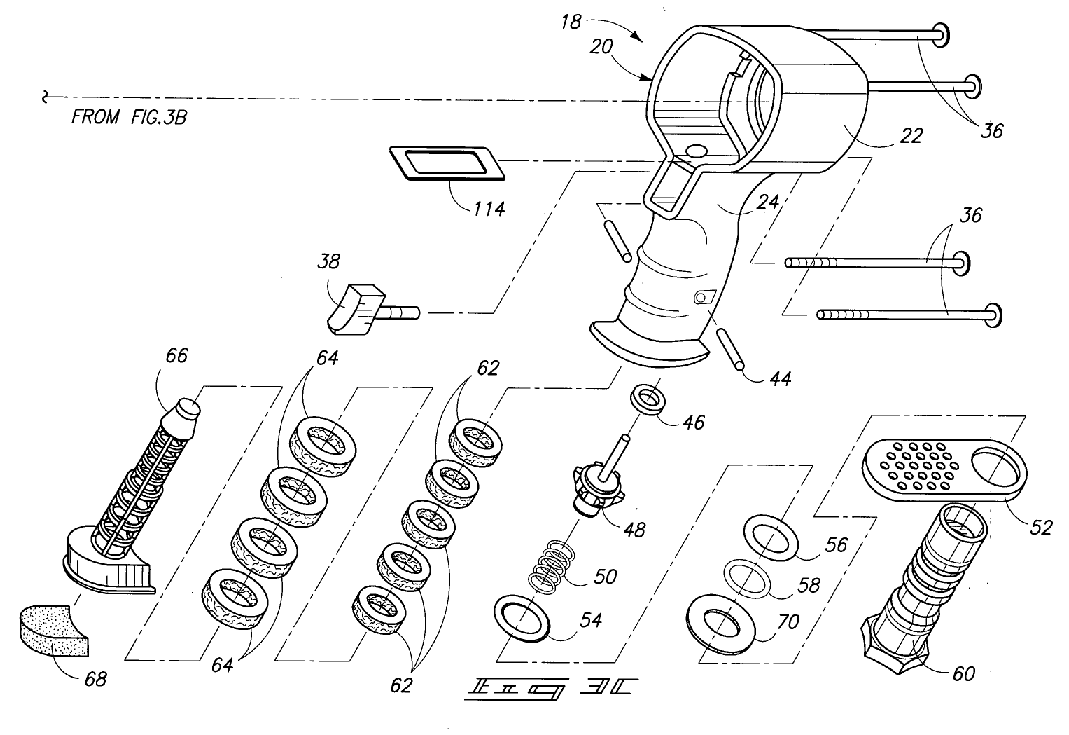

FIG. 2 illustrates assembly of an air supply, a trigger mechanism, and a muffler within handle 24 of impact wrench 10 of FIG. 1. More particularly, a trigger mechanism is provided by trigger 38 which slides in a slot within handle 24, guided further by a pin 42, to move a trigger rod 39 that tilts a valve stem 48 relative to a bushing 46 while acting against a coil seat spring 50. When depressed, trigger 38 moves valve stem 48 to an open, unsealed position relative to bushing 46 to deliver air from a source into the impact wrench. The trigger mechanism includes o-rings 54, 56, and 58, with o-ring 58 seated against a washer 70 atop an air inlet member 60 configured to receive air from an air supply such as a pressurized air line (not shown). A muffler is provided within handle 24 by two stacks of wool felt rings 62, 64 each configured with a ring-shape for mounting about a plastic exhaust tube 66. Exhaust air from the impact wrench is received through felt rings 62, 62, tube 66 and a muffler 68 where it exists handle 24 via a plurality of apertures 51 in an exhaust deflector 52. FIG. 3 further illustrates these features, along with additional construction details, as discussed below.

FIG. 3 (as assembled together via FIGS. 3A-3C) illustrates component assembly of pneumatic impact wrench 10 of FIGS. 1-2. More particularly, housing member 20 is joined to housing member 26 using screws 36 (several shown in partial breakaway view) which thread into complementarily threaded insert pieces 74 that are threaded into member 26. Anvil 16 of resilient rotary coupling device 12 is received for rotation through an anvil bushing 28 within member 26. Device 12 is directly joined to impact mechanism 14. Impact mechanism 14 comprises a twin-pin, or dog leg hammer construction having a coupling/hammer housing 75, a hammer shank 76, a pair of hammer pins 78, a hammer ball 81 entrapped between a cam 79 and a cam foundation 83, a coil spring 77, and a hammer cage 80. Hammer cage 80 is mounted for rotation onto a pneumatic motor 93 which drives cage 80 in rotation to generate impacts between hammer pins 76 and a hammer shank 76 (see FIG. 12). An air valve 95 enables adjustment of air supply to motor 93 to vary operating parameters for impact wrench 10.

Motor 93 includes a front end plate 84, a rotor 86, a plurality of rotor blades 88, and a cylinder 92. Each blade 88 is received in a respective slot 90 provided in circumferentially spaced-apart positions along rotor 86. End plate 84 receives a ball bearing assembly 82 that supports a front end of rotor 90. Cylinder 92 also receives a valve sleeve gasket 94 and a valve sleeve 96. Valve sleeve 96 receives a ball bearing assembly 98 that supports a back end of rotor 86. A reverse valve 102, an o-ring 108, a rear gasket 110, and a washer 112 are assembled between valve sleeve 96 and motor casing 22. Reverse valve 102 supports a spring pin 100, a spring 104 and a steel ball 106. An air channel gasket 114 is also mounted within motor casing 22.

According to one embodiment of the present invention, resilient rotary coupling device 12 comprises a pair of coupling members 118 and 120 that interact via a plurality of rolling members, or balls 72 to compress a plurality of frustoconical washer-shaped plate springs 73 when torsional load between members 118 and 120 exceeds the spring force of springs 73. In response, to compression of springs 73, torsional displacement occurs between members 118 and 120 which serves to attenuate shock transmission between such members 118 and 120. A pair of opposed pins 71 cooperate with members 118 and 120 to limit torsional displacement between members 118 and 120. Limited torsional displacement is provided in a forward drive direction, whereas no torsional displacement is provided in a reverse direction. Springs 65 are received around a boss 65, which is received within a bushing 67.

Member 120 is directly coupled to a hammer shank 76 (see FIG. 12) on housing 75 via pins 71 which engage within complementary slots 69 in housing 75. Housing 75 is driven via intermittent impacts with hammer pins 78 due to rotation of cage 80 via motor 93. Further details of an operating twin-pin hammer mechanism are provided in U.S. Pat. Nos. 4,313,505; 5,199,505; and 5,622,230, herein incorporated by reference. In operation, anvil 16 receives an impact socket that is coupled to a fastener. With each impact, housing 75, pins 71, and member 120 are driven in rotation. As anvil 89 (see FIG. 12) meets greater resistance when tightening a fastener, member 118 resists rotation while member 120 continues to be loaded from torsional, transient impacts from hammer 14. Rolling member 116 moves relative to members 118 and 120 to compress washer (or plate) springs 73 in order to provide torsional displacement between members 118 and 120.

As shown in FIG. 3, pins 71 are received within slots 69 of housing 75, and are further retained by a selected pair of slots provided along the outer periphery of end plate 31. End plate 31 is threaded into a complementary female thread within housing 75 in order to slightly compress springs 73. Afterwards, pins 71 are inserted when the edge slots in plate 31 align with grooves 69. In assembly, bushing 28 retains pins 71 within housing 75.

Pins 71 lock coupling member 120 relative to housing 75. Slots in coupling member 120 fit snugly against pin 71. However, elongated slots in coupling member 118 enable coupling member 118 to rotate relative to coupling member 120 in a forward, drive direction. However, slots in coupling member 118 are offset in a single direction so that no rotation occurs between members 118 and 120 in a reverse direction, such as when removing a fastener from a bolt. The degree of elongation in the slots of member 118 limit the total amount of relative torsional displacement that occurs between members 118 and 120. Such rotation results when a torsional load between housing 75 and anvil 16 exceeds the force necessary to compress springs 75. The resulting compress of spring 75 enables such torsional relative displacement which provides for shock attenuation as an impact load from hammer 14 is transmitted from hammer 14 to anvil 16 (and to a drive socket which is not shown).

As will be discussed in greater detail, relative rotation between members 118 and 120 causes members 118 and 120 to be driven axially apart as ball 72 cooperate in sloped engagement surfaces that are provided in each of members 118 and 120. Accordingly, balls 72 cooperate to provide a plurality of rolling members. Alternatively, the sloped surfaces in members 118 and 120 can be configured to accommodate other forms of rolling members, such as tapered roller bearings, roller bearings, or other rolling constructions that enable relative rotation between members 118 and 120, while providing for axial displacement therebetween as relative displacement occurs between such members.

FIG. 4 illustrates in assembly the components of impact wrench 10, including resilient rotary coupling device 12. More particularly, coupling device 12 is shown assembled between impact mechanism 14 and anvil 16. Additionally, motor 93 and air valve 95 are also shown. Except for the new and novel features of resilient rotary coupling device 12, the remaining features of wrench 10 are presently known in the art. An impact wrench with these remaining features is presently sold commercially as a ½″ composite impact wrench, but with a twin hammer, as a Model #1000^{TH}, Aircat impact wrench, from Exhaust Technologies, Inc., North 230 Division, Spokane, Wash. 99202. Further details of a construction for a twin hammer mechanism are disclosed in U.S. Pat. Nos. 3,414,065 and 6,491,111, herein incorporated by reference.

As shown in FIG. 4, resilient rotary coupling device 12 provides a limited amount of torsional displacement between a first coupling member 120 and a second coupling member 116. More particularly, rolling member 116 facilitates relative rotational displacement between members 118 and 120. Sloped surfaces on members 118 and 120 cause axial displacement of member 120 away from member 118 which is resisted by compression plate springs 73. The resistance imparted by springs 73 provides a torsional load limit which must be exceeded before any relative torsional displacement occurs between members 118 and 120. Pins 71 limit the total amount of relative displacement between members 118 and 120. Furthermore, pins 71 prevent any torsional displacement in a reverse direction according to such preferred embodiment. Alternatively, pins can be provided at intermediate locations in elongated slots such that torsional displacement can occur in forward and reverse directions.

FIGS. 5-7 illustrated one suitable construction for hammer cage 80 of the impact mechanism or hammer assembly according to such embodiment. Each hammer pin 78 is guided for axial reciprocation in a respective hammer slot 85. A hammer ball 81 is driven along an arcuate raceway 87 to-and-fro during operation, as presently understood in the art.

As shown in FIG. 6, hammer pins 78 are driven axially upwardly as a hammer ball (not shown) moves around raceway 87 to drive a cam 79 in an upward direction. A shoulder on cam 79 is received in a circumferential slot on each hammer pin 78 which drives hammer pin 78 upwardly along with cam 79 in response to a ball coacting against cam 79 as it travels around raceway 87. Arcuate raceway 87 is further defined by a cam foundation 83. The construction of hammer slots 85 within hammer cage 80 is clearly seen cooperating with hammer pin 78.

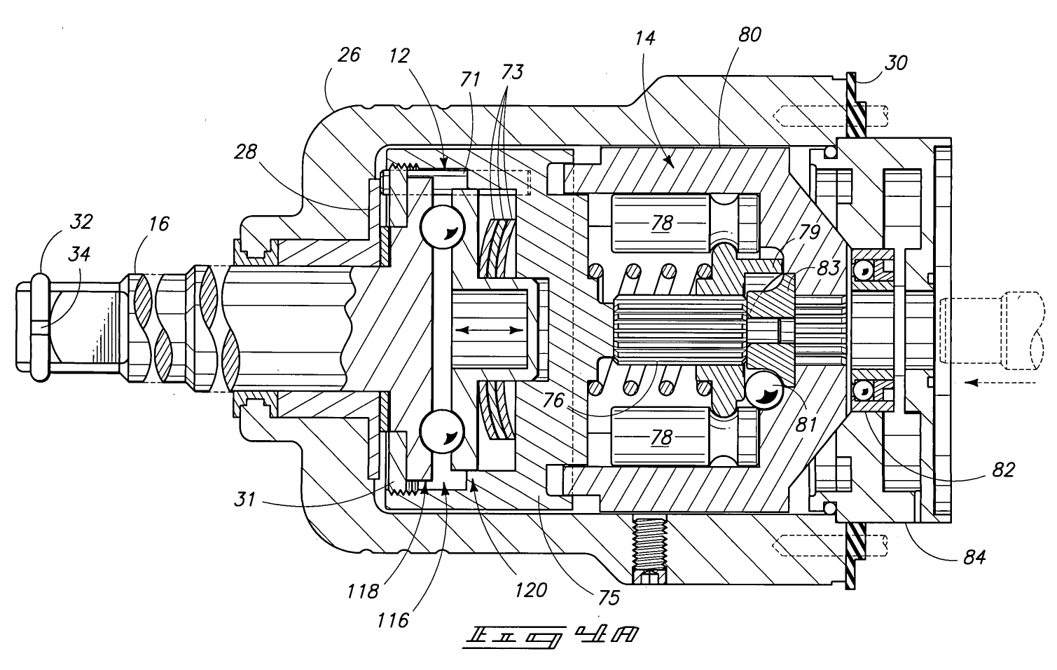

FIG. 7 further illustrates a selected one of hammer slots 87 as constructed within hammer cage 80, and further identifies the cooperation of arcuate raceway 87 and cam foundation 83 to provide a raceway for a hammer ball (not shown).

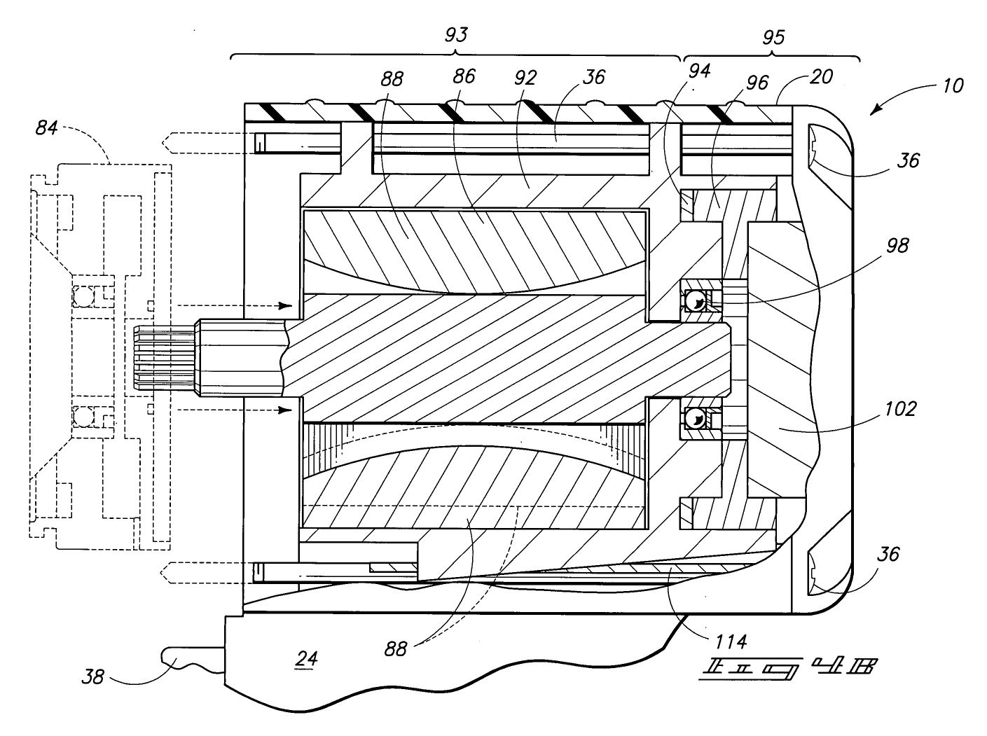

FIG. 8 further illustrates the cooperation of cam 79 and hammer ball 81. Hammer ball 81 is positioned to ride up a sloped track surface on cam 79 so as to cause movement of cam 79 which drives hammer pins into a contact or engagement position, as described below with reference to FIGS. 9-11.

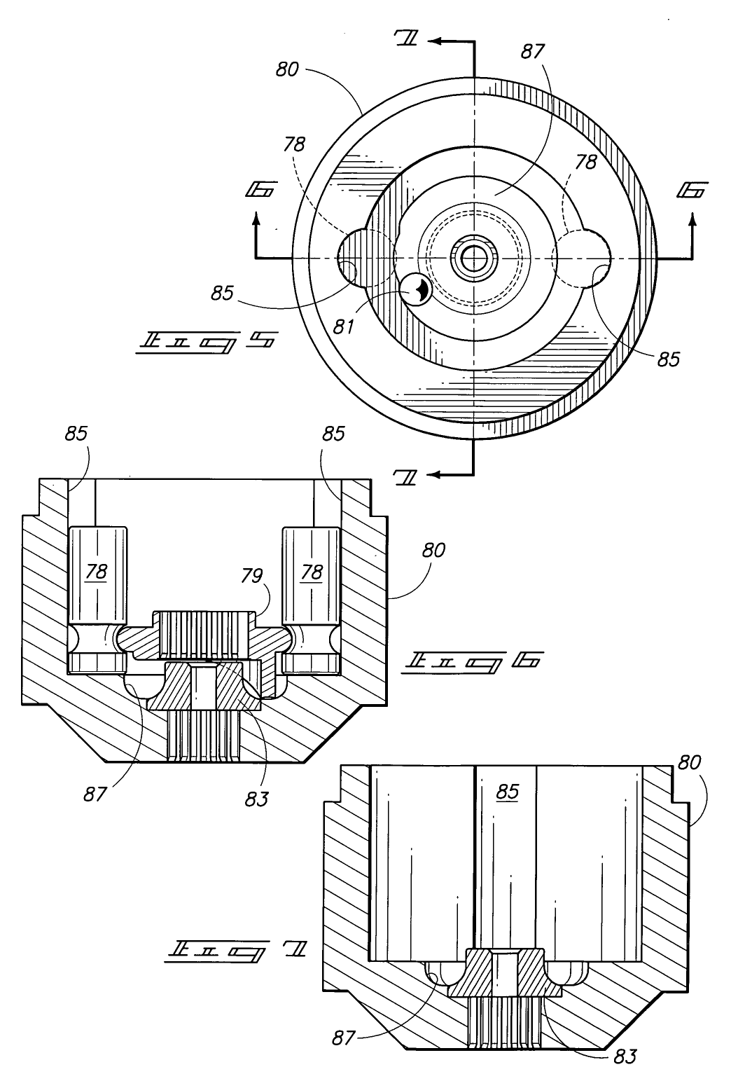

FIG. 9 illustrates the position of hammer pins 78 and cam 79 when a hammer ball 81 is provided in a lowering position between cam 79 and cam foundation 83 in hammer cage 80. FIG. 10 illustrates relative rotational movement of cam 79 relative to housing 80 as hammer ball 81 is about to ride against an increasing sloped surface on cam 79. FIG. 11 illustrates hammer pin 78 and cam 79 being driven leftwardly into a hammering position which will engage respective anvil arms (not shown) on the hammer assembly. More particularly, hammer ball 81 is riding along an upwardly extending bearing surface on cam 79 which causes cam 79 and hammer pin 78 to move in a leftward direction relative to housing 80. In operation, housing 80 is driven in rotation, whereas cam 79 is held in a stationary position relative to the resilient rotary coupling device.

FIG. 12 illustrates resilient rotary coupling device 12 in an exploded perspective view to better show cooperation between rolling member 118, coupling member 118, and coupling member 120. More particularly, rotary coupling device 12 is shown in an assembled together configuration with a hammer assembly 14. Hammer assembly 14 comprises a twin-pin hammer mechanism. However, it is understood that any form of hammer mechanism can be utilized in conjunction with resilient rotary coupling device 12, including single swing-weight hammer mechanisms, and multiple swing-weight hammer mechanisms, or other forms of rotating or centrifugal force hammer mechanisms.

As shown in FIG. 12, hammer cage 80 is assembled together such that cam 79 is received onto a fixed sliding position along a cylindrical shank 91 via splines 195 and 193, respectively. A coil spring 77 drives cam 79 upwardly which causes respective hammer pin 78 to also reside in an upward direction with hammer ball 81 engaging cam foundation 83 in a fully retracted position within housing 80. As hammer ball 81 rides up a sloped surface on cam 79, the forces of spring 77 are resisted and spring 77 compresses, allowing pins 78 to move in a downward direction along with cam 79 and to strike respective anvil arms 89 provided on housing 75. Accordingly, a hammer shank 76 is provided on housing 75 upon which a pair of anvil arms are integrally formed. After hammer pins 78 strike each respective arm 89, hammer ball 81 drops down the sloped surface of cam 79, as understood in the art, allowing spring 77 to retract cam 79 and pin 78 away from arms 89.

In assembly, springs 73 have a slightly frustoconical shape when they are unloaded, and are formed from spring steel. A center aperture in each spring 73 is received over a boss 65 on member 120. More particularly, boss 65 is integrally formed to extend upwardly from a drive plate 111 that provides coupling member 120. A plurality of circumferentially spaced apart semicircular edge slots 99 are provided about drive plate 111. An opposed pair of such slots 99 are configured to receive a respective one of pins 71 in assembly. Each pin 71 is made from case hardened steel. Accordingly, pins 71 retain drive plate 111 in fixed position rotationally relative to housing 75. Accordingly, as housing 75 is driven by hammer 14, plate 111 is likewise driven with housing 75.

Coupling member 118 comprises a driven plate 109 in which are provided a plurality of elongated edge slots 97. Edge slots 97 are configured such that, in assembly, pins 71 will be seated along one abutment edge of each slot 97, thereby providing for one way relative rotation between plates 111 and 109. Relative rotation in the opposite direction is thereby prevented.

According to one embodiment, relative torsional displacement (or rotation) occurs when peak forces are generated during the securing of a threaded fastener, such as when rotating anvil 16 in a clockwise direction. However, torsional displacement does not occur when removing a fastener, such as when rotating anvil 16 in a counterclockwise direction.

As shown in FIG. 12, pins 71 are inserted into housing 75, after assembly of end plate 31 which is threaded into a female threaded end in housing 75 to trap spring 73, members 118 and 120, and rolling member 116 in compression therein. Respective semi-circumferential slots 105 in end plate 131 are selectively positioned to receive each of pins 71 when spring 73 have been slightly compressed. A pair of apertures 107 are provided in end plate 31 to facilitate rotational insertion within housing 75 using a tool having a pair of drive pins. In assembly, anvil 16 extends through an aperture within end plate 31. Additionally, a thrust bearing 29 is assembled on the outside of end plate 31.

Also shown in FIG. 12, rolling member 116 comprises a plurality of hardened steel balls 103 that seat within a lowermost position of a groove, or slope bearing raceway 101 provided in driven plate 109.

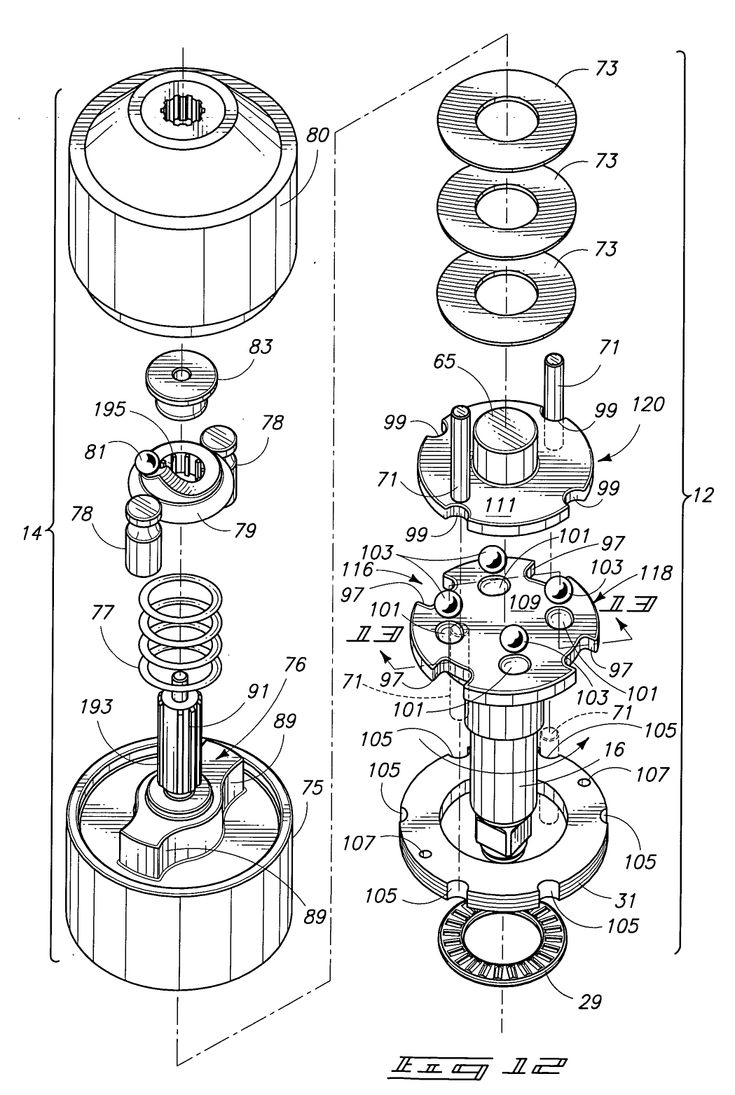

FIGS. 13 and 14 illustrate components of the resilient rotary coupling device 12 while omitting the washer springs. More particularly, FIG. 13 illustrates first coupling member 120 and second coupling member 118, each formed from case hardened steel, and cooperating through rolling member 116 when resilient rotary coupling device 12 is under torsional loading that is below a threshold value capable of compressing the washer springs 73 (see FIG. 12). More particularly, each ball 103 is compressed (by the washer springs) to drive the ball to a lower-most position in each respective ramped groove provided within driven plate 109 and drive plate 111, respectively. In contrast, FIG. 14 illustrates repositioning of balls 103 as they move out of the lower-most position within each respective ramped groove provided in plates 109 and 111. Movement of balls 103 along the ramped grooves, or raceways within plates 109 and 111 causes coupling member 120 to be pushed axially away from coupling member 118, as illustrated in FIG. 14. Accordingly, coupling members 118 and 120 are further separated by the rolling movement of rolling member 116 therebetween. As coupling member 120 is driven upwardly, washer springs 73 (see FIG. 12) are accordingly compressed to accommodate the axial translation of coupling member 120 relative to coupling member 118. Such action against the washer springs imparts shock attenuation between members 118 and 120, as member 120 is being driven by the impact mechanism, or hammer 14 (see FIG. 12).

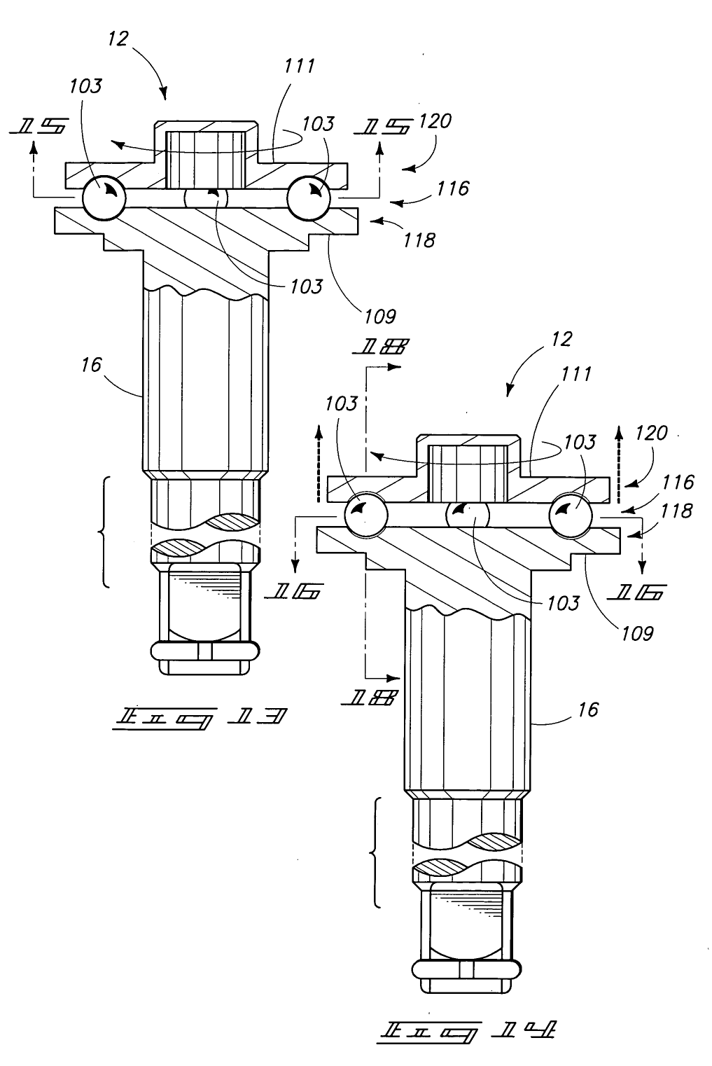

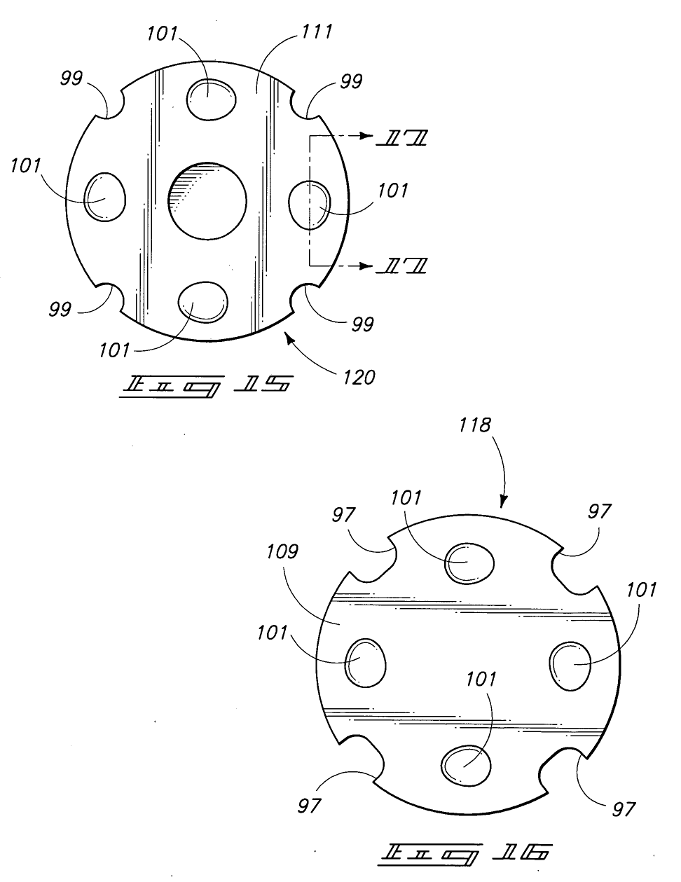

FIGS. 15 and 16 illustrate in greater detail the arrangement of each set of ramped grooves, or sloped recesses 101 provided within respective plates 111 and 109 of FIGS. 15 and 16, respectively. Additionally, FIG. 15 illustrates the semi-circular construction of edge slots 99 along an outer peripheral edge of plate 111. Likewise, FIG. 16 illustrates the elongated construction of edge slots 97 provided in an outer periphery of plate 109. Accordingly, coupling member 120 of FIG. 15 and coupling member 118 of FIG. 16, when assembled together, provide sloped recesses that slope in opposing directions. For example, one set of recesses slopes in a clockwise direction while another set of recesses slopes in a counterclockwise direction, in assembly.

FIG. 17 illustrates the construction of such sloped recesses 101 within a selected one of coupling member 118; namely within plate 109. One construction technique for forming a sloped recess or ball bearing raceway 101 is to use a spherical head milling bit 150 which is used to cut sloped recess 101 into an exposed surface of plate 109. Accordingly, sloped recess 101 is constructed by tilting milling bit 150 at an angle, such as an angle in the range of 35-40 degrees which provides one preferable angular orientation. However, it is possible to form sloped recess 101 using other angles outside the range of 35-40 degrees. Optionally, the slope can extend circumferential in both directions.

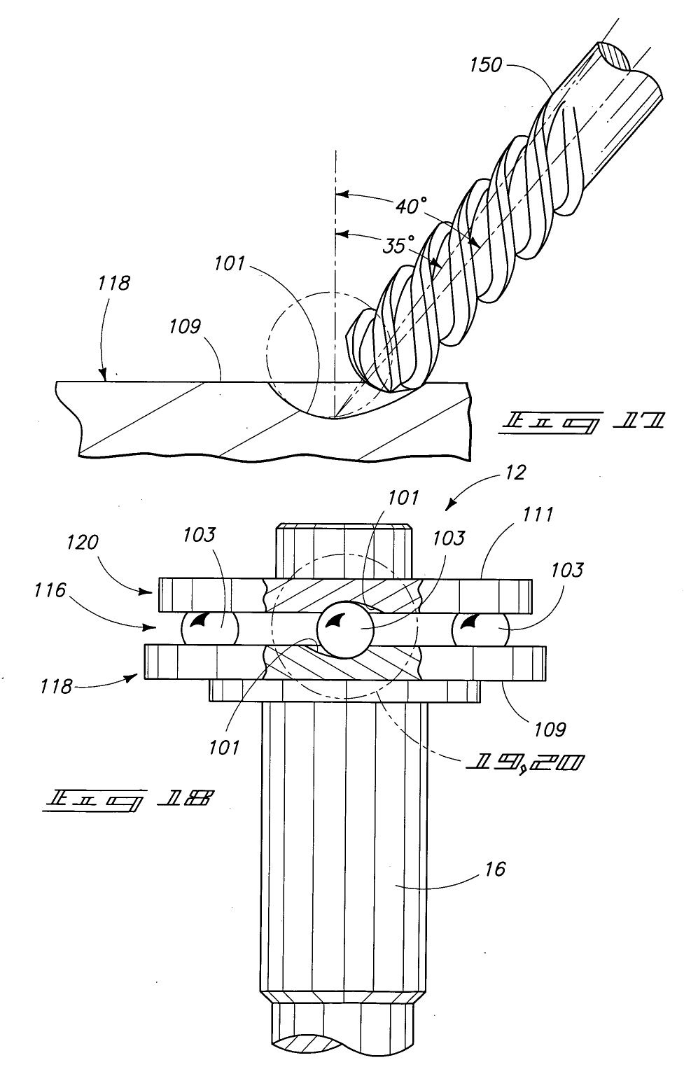

FIG. 18 further illustrates the construction of resilient rotary coupling device 12 by showing a selected ball 103 provided in a lower-most position of each ramped groove 101 in respective plates 109 and 111 of member 120 and 118, respectively. Accordingly, balls 103 cooperate to provide rolling members 116 between coupling members 118 and 120. Relative rotation between members 118 and 120 causes balls 103 to climb up each sloped recess 101, thereby causing upward displacement of member 120 against the respective washer springs (not shown).

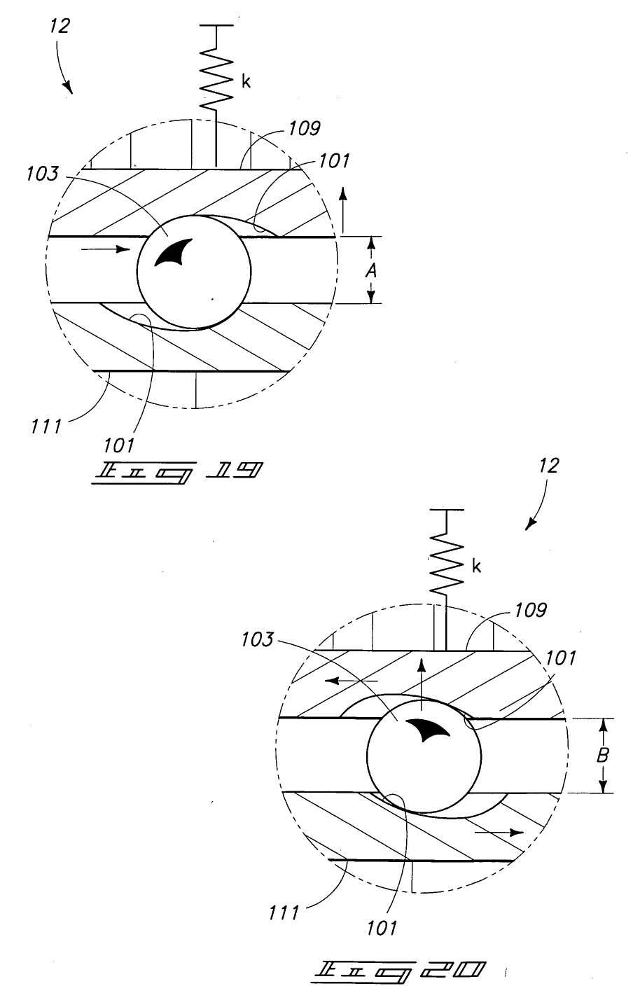

FIG. 19 illustrates in enlarged view the positioning of a selected ball 103 within corresponding sloped recesses or ball bearing raceways 101 within plates 109 and 111. The compressed washer springs are shown in simplified form as a spring “k” against which plate 109 is upwardly compressed as ball 103 rolls up the sloped recess 101 of plates 109 and 111.

FIG. 20 illustrates ball 103 after rolling up each sloped recess 101 so as to compress the respective washer springs represented by spring “k”. A comparison of FIGS. 19 and 20 shows that clearance dimension “A” of FIG. 19 is less than clearance dimension “V” of FIG. 20 which results from ball 103 riding up sloped recesses 101 so as to compress spring “K” by an amount comprising the difference between dimension “B” and dimension “A”. Such action between plates 109 and 111 against the washer springs provides torsional displacement therebetween and shock attenuation resulting from the compression of the washer springs.

The shock attenuating coupling device as used in the impact wrench in FIGS. 1-20 is relatively compact when compared with prior art rotary impact devices. Furthermore, such construction provides improvements in the ability to handle long term cyclical loading without failure over other previously known constructions for attenuating shock transmission through a rotary impact tool.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A shock attenuating coupling device for a rotary impact tool for drivingly connecting a hammer mechanism to a drive anvil, comprising:
a first coupling member having a longitudinal drive portion with an input end configured to couple for rotation with a hammer mechanism and an output end with a first engagement portion having a first ramped groove;
a second coupling member coaxial with the first coupling member and having an output end configured to couple for rotation with a drive anvil and an input end with a second engagement portion having a second ramped groove extending in a direction opposite a direction of the first ramped groove and configured to cooperate with the first engagement portion;
a rolling member provided between the first ramped groove and the second ramped groove; and
a spring configured to engage together the first engagement portion and the second engagement portion to drive the rolling member to a resting lower-most position within each of the first ramped groove and the second ramped groove.

2. The shock attenuating coupling device of claim 1, wherein the first engagement portion has a plurality of ramped, circumferential grooves spaced circumferentially about the first engagement portion, and the second engagement portion has a complementary plurality of ramped, circumferential grooves spaced circumferentially about the second engagement portion.

3. The shock attenuating coupling device of claim 2, wherein the spring comprises a plurality of nested plate springs configured to engage in compression with one of the first coupling member and the second coupling member.

4. The shock attenuating coupling device of claim 2, wherein the rolling member is a ball.

5. The shock attenuating coupling device of claim 4, wherein the first ramped, circumferential groove provides a counterclockwise sloped ball bearing raceway, and the second ramped, circumferential groove provides a clockwise sloped ball bearing raceway.

6. The shock attenuating coupling device of claim 1, further comprising a rotation-limiting mechanism.

7. The shock attenuating coupling device of claim 6, wherein the rotation-limiting mechanism comprises a stop pin configured to engage between the first engagement portion and the second engagement portion, one of the first engagement portion and the second engagement portion having a circumferential clearance slot configured to provide clearance for the pin with each end of the slot providing a respective engagement surface for limiting relative rotation between the first coupling member and the second coupling member.

8. The shock attenuating coupling device of claim 7, wherein the rotation-limiting mechanism comprises a pair of the stop pins and a pair of the circumferential clearance slots.

9. The shock attenuating coupling device of claim 8, wherein the first engagement portion comprises a cylindrical drive plate having a pair of opposed edge slots each configured to receive a respective one of the stop pins, and the second engagement portion comprises a cylindrical driven plate having the pair of opposed clearance slots.

10. The shock attenuating coupling device of claim 9, wherein the opposed clearance slots of the cylindrical driven plate each comprise an elongated edge slot.

11. The shock attenuating coupling device of claim 1, further comprising a housing configured to receive the first coupling member, the second coupling member, the rolling member and the spring in compressively engaged relation.

12. A rotary impact tool, comprising:
a housing;
a hammer mechanism;
a drive anvil; and
a resilient rotary coupling device having a pair of engagement plates provided in coaxial relation, each plate having a sloped circumferential engagement surface, a rolling element interposed between the engagement surfaces, and a compression spring configured to drive together the pair of engagement plates;
wherein relative rotational displacement between the hammer mechanism and the drive anvil causes the rolling element to translate up each sloped circumferential engagement surface acting to compress the spring so as to attenuate impact forces from the hammer mechanism to the drive anvil.

13. The rotary impact tool of claim 12, further comprising a pneumatic motor.

14. The rotary impact tool of claim 13, wherein the hammer mechanism comprises a pair of axially slidable hammer pins and an anvil configured to impact with the hammer pins.

15. The rotary impact tool of claim 12, wherein the resilient rotary coupling device further comprises a rotational limiting mechanism provided between the engagement plates to limit torsional displacement between the hammer mechanism and the drive anvil.

16. The rotary impact tool of claim 15, wherein the rolling element is a ball and each sloped engagement surface comprises a sloped ball bearing raceway.

17. The rotary impact tool of claim 16, wherein one of the sloped ball bearing raceways extends in a clockwise direction and another of the sloped ball bearing raceways extends in a counterclockwise direction.

18. The rotary impact tool of claim 12, wherein the resilient rotary coupling device comprises a rotation-limiting mechanism.

19. The rotary impact tool of claim 18, wherein the rotation-limiting mechanism comprises a pair of end stops and an abutment member constrained for movement between the end stops.

20. The rotary impact tool of claim 19, wherein the abutment member comprises a stop pin, and an elongated slot is provided in one of the engagement plates, with opposed ends of the slot providing the end stops.

21. The rotary impact tool of claim 12, wherein the resilient rotary coupling device provides constrained torsional displacement between the hammer mechanism and the anvil in a first drive direction, but does not provide torsional displacement in a second, opposite direction.

22. A rotary impact attenuating device for an impact tool, comprising:
a first coupling member having a drive shaft and a drive plate with a sloped raceway;
a second coupling member coaxial with the first coupling member and having a driven shaft and a driven plate with a sloped raceway;
a rolling element engaged between the rolling raceways; and
a spring compressively engaged against one of the first coupling member and the second coupling member to drive the rolling element to a lowermost position in each of the rolling raceways when below a threshold torque limit.

23. The rotary impact attenuating device of claim 22, wherein the rolling element and the rolling raceways cooperate to provide a ball bearing.

24. The rotary impact attenuating device of claim 23, wherein the each of the rolling raceways comprise a circumferential groove having a uniformly varying depth along their length from a minimum to a maximum.

25. The rotary impact attenuating device of claim 24, wherein a plurality of the circumferential grooves are provided in each of the drive plate, and the driven plate, and a corresponding plurality of balls are provided.

26. The rotary impact attenuating device of claim 25, wherein the circumferential grooves in the drive plate are arrayed in one of a clockwise and a counterclockwise direction, and the circumferential grooves in the driven plate are arrayed in another of the clockwise and the counterclockwise direction.

27. The rotary impact attenuating device of claim 26, further comprising a torsional displacement limiting mechanism provided between the drive plate and the driven plate.

28. The rotary impact attenuating device of claim 23, wherein the drive plate comprises a central boss and the spring comprises a plurality of cylindrical plate springs each having an aperture sized to be received over the boss.
